(19) United States
(12) Patent Application Publication
(10) Pub. No.: US 2009/0182040 A1
(43) Pub. Date: Jul. 16, 2009

(54) Method of Preventing or Reducing Insecticidal Resistance

(75) Inventors: Martin Heger, Hofbieber (DE); Herve R. Vantieghem, Stutensee (DE)

Correspondence Address: BRINKS, HOFER, GILSON & LIONE, P.O. BOX 1340, MORRISVILLE, NC, 27560, US

(73) Assignee: BASF SE, Ludwigshafen (DE)

(21) Appl. No.: 12/300,395

(22) PCT Filed: May 11, 2007
(86) PCT No.: PCT/EP2007/054556

§ 371 Date: Nov. 11, 2008

(30) Foreign Application Priority Data
May 16, 2006 (EP) 06114040.6

(51) Int. Cl. A01N 43/30; A01P 7/04

(52) U.S. Cl. 514/464

(57) ABSTRACT

The present invention relates to a method of preventing or reducing insecticidal resistance of adult insect pests of the family Nitidulidae, the family Curculionidae and Psylliodes spp. which method comprises contacting the plant or the soil or water in which the plant is growing, or the pest or its food supply, habitat, breeding grounds or locus, with pesticidally effective amounts of piperonyl butoxide and at least one pyrethroid, wherein piperonyl butoxide and the pyrethroid are applied in a weight ratio of from 0.0001 to 10000.

The present invention relates to a method of preventing or reducing insecticidal resistance of adult insect pests of the family Nitidulidae, the family Curculionidae and Psylliodes ssp.

Insecticide resistance is a major obstacle to the control of agricultural pests. The number of resistant species has exploded in the last half of the twentieth century and resistance has now been documented in over 500 species of insects. Resistance is defined by the World Health Organization as “the development of an ability in a strain of an organism to tolerate doses of toxicant, which would prove lethal to a majority of individuals in a normal (susceptible) population of the same species” (WHO Expert Committee on Insecticides).

Insecticide resistance can arise in several different ways, e.g. through behavioral avoidance, reduced uptake, increased detoxification of the insecticide, and target-site insensitivity. These resistance mechanisms may exist individually in an insect, but are often found in combination (commonly referred to as “multifactorial resistance”).

The two major forms of biochemical resistance are target-site resistance, which occurs when the insecticide no longer binds to its target, and detoxification enzyme-based resistance, which occurs when enhanced levels or modified activities of esterases, oxidases, or glutathione S-transferases (GST) prevent the insecticide from reaching its site of action. The enzymes responsible for detoxification of pesticides in many insects are transcribed by members of large multigene families of esterases, oxidases, and GST. Perhaps the most common resistance mechanisms in insects are modified levels or activities of esterase detoxification enzymes that metabolize (hydrolyze ester link-ages of) a wide range of insecticides, e.g. organophosphates, carbamates and pyrethroids.

Conventional strategies for resistance management include the growing of different varieties of the crop, the growing of different crops or the usage of insecticides with a new or different mode of action. Also, the use of certain synergists has been considered in the resistance management of certain insects.

Synergists are compounds which, whilst lacking pesticidal properties of their own, enhance the pesticidal properties of other active ingredients. For example, piperonyl butoxide (herein also referred to as “PBO”, chemical name: 5-[[2-(2-butoxyethoxy) ethoxy]methyl]-6-propyl-1,3-benzodioxole) has been used as synergist with various pesticides, e.g. pyrethroids.

Gunning et al. reported the inhibition of pyrethroid-resistance related esterases by piperoyl butoxide in larvae of Australian Helicoverpa armigera (Hübner) and Aphis gossypii (Glover), cf. Gunning et al. in Piperonyl Butoxide, pp. 215-26, Academic Press, 1998.

Studies on the detoxification of larvae of Cyclocephala comata Bates to pyrethroid and phosphorated insecticides by using piperonyl butoxide as synergist have been reported by Ponce P. P. et al (see Resistant Pest Management Newsletter, Vol. 14, No. 2, Spring 2005, Center for Integrated Plant Systems, Michigan State University, pp. 17-19).

US 2005/0255137 A1 discloses that the application of the synergist PBO and a delayed release pyrethroid on cotton controlled highly pyrethroid resistant larvae of Helicoverpa armigera (Hübner) and B-biotype Bemisia tabaci.

The effect of PBO on the development of deltamethrin resistance in the yellow fever mosquito (Aedes aegypti L.) has been studied by Kumar et al., see Arch Insect Biochem Physiol. 2002, 50(1): 1-8.

Soderlund et al. describes studies on the toxicity of fenvalerate to resistant Colorado potato beetles by coapplication of piperonyl butoxide (see J. Agric. Food Chem. 1987, Vol. 35, pp. 100-105).

Collins et al. relates to the management of organophosphorus insecticide resistance in the banana weevil borer (see Crop Protection, Vol. 10, June 1991, pp. 215-221). It is reported that resistance to pirimiphos and prothiofos was almost completely sup-pressed with the synergist piperonyl butoxide.

Ahammad-Sahib et al. discloses that piperonyl butoxide pretreatment increased the toxicity of azinphosmethyl in resistant strains of the Colorado potato beetle (see Pesticide Biochemistry and Physiology, Vol. 49, 1994, pp. 1-12).

Mota-Sanchez et al. relates to the resistance and cross-resistance to neonicotinoid insecticides and spinosad in the Colorado potato beetle (see Pest Management Science, Vol. 62, 2006, pp. 30-37). It is reported that piperonyl butoxide partially sup-pressed resistance to imidacloprid.

Miota et al. is concerned with studies on the mechanisms of methyl parathion and ethyl parathion resistance in the Western corn rootworm (see Pesticide Biochemistry and Physiology, Vol. 61, 1998, pp. 39-52). It was observed that resistance was partially suppressed by piperonyl butoxide.

Ballanger, Y. mentions that the combined use of piperonyl butoxide and pyrethroids against Meligethes species gave promising results on mustard crops (see Oléoscope, No. 70, May 2003, pp. 29-31).

However, there remains a need for commercially valuable methods for preventing or reducing the pyrethroid resistance in adult beetles of the family Nitidulidae, the family Curculionidae and Psylliodes spp.

For example, the pollen beetle (Meligethes aeneus) is one of the most serious oil seed rape pest in certain European countries (e.g. Germany) and considered to be a pest with a high likelihood of developing insecticide resistance. In the spring, adult pollen beetles fly to winter oilseed rape crops. They initially colonise the field margins before venturing further into the crop. The adult beetles feed on pollen. This means they are of no threat to crops in flower, but at green and yellow bud growth stages, they can dam-age the flowers. The cases of observed pollen beetle resistance to pyrethroids is steadily increasing.

It was therefore an object of the present invention to provide new methods for commercially applicable management of pyrethroid resistance in adult beetles of the family Nitidulidae, the family Curculionidae and Psylliodes spp.

We have found that this object is in part or in whole achieved by a method of preventing or reducing insecticidal resistance of adult insect pests selected from the family Nitidulidae, the family Curculionidae and Psylliodes spp., which method comprises contacting the plant or the soil or water in which the plant is growing, or the pest or its food supply, habitat, breeding grounds or locus, with pesticidally effective amounts of piperonyl butoxide and at least one pyrethroid, wherein piperonyl butoxide and the pyrethroid are applied in a weight ratio of from 0.0001 to 10000.

As used herein, the term “adult insect pests” refers to insects in the adult stage of the insect metamorphosis.

In accordance with the invention, the pest is selected from the family Nitidulidae, the family Curculionidae and Psylliodes spp.

Preferably, the pest is of the family Nitidulidae, more preferably Meligethes spp. and is in particular Meligethes aeneus.

In another embodiment, the pest is of the family Curculionidae, preferably Ceutorhynchus spp. and is in particular selected from Ceutorhynchus assimilis, Ceutorhynchus napi, Ceutorhynchus picitarsis and Ceutorhynchus quadriedens.

In another embodiment, the pest is selected from Psylliodes spp. and is in particular Psylliodes chrysocephala.

In another embodiment, the pest is selected from Meligethes spp., Ceutorhynchus spp. and Psylliodes spp.

In yet another preferred embodiment, the pest is selected from Ceutorhynchus assimilis, Ceutorhynchus napi, Ceutorhynchus picitarsis, Ceutorhynchus quadriedens, Meligethes aeneus and Psylliodes chrysocephala.

The term “plant” includes any plant species to which piperonyl butoxide and the pyrethroid can be administered, in particular crop plants such as, for example, corn, potato, oilseed rape, mustard, alfalfa, sunflower, cotton, celery, soybean, tobacco, legumes, cereals, and sugarbeet.

The inventive method is especially useful for the control of the above-mentioned pests in crops of Brassica spp., in particular oilseed rape crops. It should be understood that the oilseed rape crops may be of either the summer or winter types.

The inventive method is especially useful for the control of Meligethes spp. (in particular Meligethes aeneus) in oilseed rape crops.

The inventive method is especially useful for preventing or reducing detoxification enzyme-based resistance (in particular esterase-based metabolic resistance) of the aforementioned adult insect pests.

Preferably, the pyrethroid is selected from allethrin, bifenthrin, cyfluthrin, cyhalothrin, cyphenothrin, cypermethrin, alpha-cypermethrin, beta-cypermethrin, zeta-cypermethrin, deltamethrin, empenthrin, esfenvalerate, etofenprox, fenpropathrin, fenvalerate, imiprothrin, lambda-cyhalothrin, permethrin, prallethrin, pyrethrin I and II, resmethrin, si-lafluofen, tau-fluvalinate, tefluthrin, tetramethrin, tralomethrin, transfluthrin, profluthrin and dimefluthrin.

More preferably, the pyrethroid is selected from bifenthrin, alpha-cypermethrin, deltamethrin, esfenvalerate, etofenprox, lambda-cyhalothrin, pyrethrin I and II, taufluvalinate and tefluthrin.

Particularly preferred are pyrethroids selected from bifenthrin, alpha-cypermethrin, etofenprox, lambda-cyhalothrin, pyrethrin I and II, and tau-fluvalinate.

In another preferred embodiment, the pyrethroid is alpha-cypermethrin.

In yet another preferred embodiment, the pyrethroid is lambda-cyhalothrin.

More preferably, a composition comprising piperonyl butoxide and a pyrethroid or a mixture of pyrethroids (in particular selected from the aforementioned pyrethroids) is used in the inventive method. It is particularly preferred to use a composition comprising piperonyl butoxide and alpha-cypermethrin or a composition comprising piperonyl butoxide and lambda-cyhalothrin.

Piperonyl butoxide and the pyrethroids as mentioned hereinabove are all commercially available compounds which may be found in The Pesticide Manual, 13th Edition, British Crop Protection Council (2003) among other publications.

For their use according to the present invention, piperonyl butoxide and the pyrethroid can be converted into the customary formulations, for example solutions, emulsions, suspensions, dusts, powders, pastes and granules. The use form depends on the particular intended purpose; in each case, it should ensure a fine and even distribution of the compounds according to the invention. The terms “active compound(s)”, “active ingredient(s)” or “active substance(s)” as used hereinbelow should be understood to refer to both piperonyl butoxide and the pyrethroid, although piperonyl butoxide does not exhibit pesticidal activity.

The formulations are prepared in a known manner (see e.g. for review U.S. Pat. No. 3,060,084, EP-A 707 445 (for liquid concentrates), Browning, “Agglomeration”, Chemical Engineering, Dec. 4, 1967, 147-48, Perry's Chemical Engineer's Handbook, 4th Ed., McGraw-Hill, New York, 1963, pages 8-57 and et seq. WO 91/13546, U.S. Pat. No. 4,172,714, U.S. Pat. No. 4,144,050, U.S. Pat. No. 3,920,442, U.S. Pat. No. 5,180,587, U.S. Pat. No. 5,232,701, U.S. Pat. No. 5,208,030, GB 2,095,558, U.S. Pat. No. 3,299,566, Klingman, Weed Control as a Science, John Wiley and Sons, Inc., New York, 1961, Hance et al., Weed Control Handbook, 8th Ed., Blackwell Scientific Publications, Oxford, 1989 and Mollet, H., Grubemann, A., Formulation technology, Wiley VCH Verlag GmbH, Weinheim (Germany), 2001, 2. D. A. Knowles, Chemistry and Technology of Agrochemical Formulations, Kluwer Academic Publishers, Dordrecht, 1998 (ISBN 0-7514-0443-8), for example by extending the active compound with auxiliaries suitable for the formulation of agrochemicals, such as solvents and/or carriers, if desired surfactants (e.g. adjuvans, emulsifieres, dispersing agents), preservatives, antifoaming agents, anti-freezing agents.

Examples of suitable solvents are water, aromatic solvents (for example Solvesso pro-ducts, xylene), paraffins (for example mineral oil fractions), alcohols (for example methanol, butanol, pentanol, benzyl alcohol), ketones (for example cyclohexanone, gam-ma-butyrolactone), pyrrolidones (NMP, NOP), dialkylsulfoxides (for example dimethyl-sulfoxide), acetates (glycol diacetate), glycols, fatty acid dimethylamides, fatty acids and fatty acid esters. In principle, solvent mixtures may also be used.

Suitable surfactants used are alkali metal, alkaline earth metal and ammonium salts of lignosulfonic acid, naphthalenesulfonic acid, phenolsulfonic acid, dibutylnaphthalenesulfonic acid, alkylarylsulfonates, alkyl sulfates, alkylsulfonates, fatty alcohol sulfates, fatty acids and sulfated fatty alcohol glycol ethers, furthermore condensates of sulfonated naphthalene and naphthalene derivatives with formaldehyde, condensates of naphthalene or of naphthalenesulfonic acid with phenol and formaldehyde, polyoxyethylene octylphenol ether, ethoxylated isooctylphenol, octylphenol, nonylphenol, alkylphenol polyglycol ethers, tributylphenyl polyglycol ether, tristearylphenyl polyglycol ether, alkylaryl polyether alcohols, alcohol and fatty alcohol ethylene oxide condensates, ethoxylated castor oil, polyoxyethylene alkyl ethers, ethoxylated polyoxypropylene, lauryl alcohol polyglycol ether acetal, sorbitol esters, lignosulfite waste liquors and methylcellulose.

Substances which are suitable for the preparation of directly sprayable solutions, emulsions, pastes or oil dispersions are mineral oil fractions of medium to high boiling point, such as kerosene or diesel oil, furthermore coal tar oils and oils of vegetable or animal origin, aliphatic, cyclic and aromatic hydrocarbons, for example toluene, xylene, paraffin, tetrahydronaphthalene, alkylated naphthalenes or their derivatives, methanol, ethanol, propanol, butanol, cyclohexanol, cyclohexanone, isophorone, highly polar solvents, for example dimethyl sulfoxide, N-methylpyrrolidone or water.

Also anti-freezing agents such as glycerin, ethylene glycol, propylene glycol and bactericides such as can be added to the formulation.

Suitable antifoaming agents are for example antifoaming agents based on silicon or magnesium stearate.

Suitable preservatives are for example Dichlorophen und enzylalkoholhemiformal.

Powders, materials for spreading and dustable products can be prepared by mixing or concomitantly grinding the active substances with a solid carrier.

Granules, for example coated granules, impregnated granules and homogeneous granules, can be prepared by binding the active compounds to solid carriers.

Examples of solid carriers are mineral earths such as silica gels, silicates, talc, kaolin, attaclay, limestone, lime, chalk, bole, loess, clay, dolomite, diatomaceous earth, calcium sulfate, magnesium sulfate, magnesium oxide, ground synthetic materials, fertilizers, such as, for example, ammonium sulfate, ammonium phosphate, ammonium nitrate, ureas, and products of vegetable origin, such as cereal meal, tree bark meal, wood meal and nutshell meal, cellulose powders and other solid carriers.

In general, the formulations comprise from 0.01 to 95% by weight, preferably from 0.1 to 90% by weight, of the active compounds. In this case, the active compounds are employed in a purity of from 90% to 100% by weight, preferably 95% to 100% by weight (according to NMR spectrum).

Piperonyl butoxide and the pyrethroid can be used as such, in the form of their formulations or the use forms prepared therefrom, for example in the form of directly sprayable solutions, powders, suspensions or dispersions, emulsions, oil dispersions, pastes, dustable products, materials for spreading, or granules, by means of spraying, atomizing, dusting, spreading or pouring. The use forms depend entirely on the intended purposes; it is intended to ensure in each case the finest possible distribution of the active compounds according to the invention.

Aqueous use forms can be prepared from emulsion concentrates, pastes or wettable powders (sprayable powders, oil dispersions) by adding water. To prepare emulsions, pastes or oil dispersions, the substances, as such or dissolved in an oil or solvent, can be homogenized in water by means of a wetter, tackifier, dispersant or emulsifier. Alternatively, it is possible to prepare concentrates composed of active substance, wet-ter, tackifier, dispersant or emulsifier and, if appropriate, solvent or oil, and such concentrates are suitable for dilution with water.

The active compound concentrations in the ready-to-use preparations can be varied within relatively wide ranges. In general, they are from 0.0001 to 10%, preferably from 0.01 to 1% per weight.

The active compound(s) may also be used successfully in the ultra-low-volume process (ULV), it being possible to apply formulations comprising over 95% by weight of active compound, or even to apply the active compound without additives.

The following are examples of formulations: 1. Products for dilution with water for foliar applications.

### A) Water-Soluble Concentrates (SL)

10 parts by weight of the active compound(s) are dissolved in 90 parts by weight of water or a water-soluble solvent. As an alternative, wetters or other auxiliaries are added. The active compound(s) dissolves upon dilution with water, whereby a formulation with 10% (w/w) of active compound(s) is obtained.

### B) Dispersible Concentrates (DC)

20 parts by weight of the active compound(s) are dissolved in 70 parts by weight of cyclohexanone with addition of 10 parts by weight of a dispersant, for example polyvinylpyrrolidone. Dilution with water gives a dispersion, whereby a formulation with 20% (w/w) of active compound(s) is obtained.

### C) Emulsifiable Concentrates (EC)

15 parts by weight of the active compound(s) are dissolved in 7 parts by weight of xylene with addition of calcium dodecylbenzenesulfonate and castor oil ethoxylate (in each case 5 parts by weight). Dilution with water gives an emulsion, whereby a formulation with 15% (w/w) of active compound(s) is obtained.

### D) Emulsions (EW, EO)

25 parts by weight of the active compound(s) are dissolved in 35 parts by weight of xylene with addition of calcium dodecylbenzenesulfonate and castor oil ethoxylate (in each case 5 parts by weight). This mixture is introduced into 30 parts by weight of water by means of an emulsifier machine (e.g. Ultraturrax) and made into a homogeneous emulsion. Dilution with water gives an emulsion, whereby a formulation with 25% (w/w) of active compound(s) is obtained.

### E) Suspensions (SC, OD)

In an agitated ball mill, 20 parts by weight of the active compound(s) are comminuted with addition of 10 parts by weight of dispersants, wetters and 70 parts by weight of water or of an organic solvent to give a fine active compound(s) suspension. Dilution with water gives a stable suspension of the active compound(s), whereby a formulation with 20% (w/w) of active compound(s) is obtained.

### F) Water-Dispersible Granules and Water-Soluble Granules (WG)

50 parts by weight of the active compound(s) are ground finely with addition of 50 parts by weight of dispersants and wetters and made as water-dispersible or water-soluble granules by means of technical appliances (for example extrusion, spray tower, fluidized bed). Dilution with water gives a stable dispersion or solution of the active compound(s), whereby a formulation with 50% (w/w) of active compound(s) is obtained.

### G) Water-Dispersible Powders and Water-Soluble Powders (WP, SP)

75 parts by weight of the active compound(s) are ground in a rotor-stator mill with addition of 25 parts by weight of dispersants, wetters and silica gel. Dilution with water gives a stable dispersion or solution of the active compound(s), whereby a formulation with 75% (w/w) of active compound(s) is obtained.

### 2. Products to be Applied Undiluted for Foliar Applications.

### I) Dustable Powders (DP)

5 parts by weight of the active compound(s) are ground finely and mixed intimately with 95 parts by weight of finely divided kaolin. This gives a dustable product having 5% (w/w) of active compound(s)

### J) Granules (GR, FG, GG, MG)

0.5 part by weight of the active compound(s) is ground finely and associated with 95.5 parts by weight of carriers, whereby a formulation with 0.5% (w/w) of active compound(s) is obtained. Current methods are extrusion, spray-drying or the fluidized bed. This gives granules to be applied undiluted for foliar use.

### K) ULV Solutions (UL)

10 parts by weight of the active compound(s) are dissolved in 90 parts by weight of an organic solvent, for example xylene. This gives a product having 10% (w/w) of active compound(s), which is applied undiluted for foliar use.

Compositions of this invention may also contain other active ingredients, for example other oils, wetters, adjuvants, herbicides, fungicides, insecticides, herbicides, fertilizers such as ammonium nitrate, boron, molybdenum, sulfur, urea, potash, and superphosphate, phytotoxicants and plant growth regulators, safeners and nematicides. These additional ingredients may be used sequentially or in combination with the above-described compositions, if appropriate also added only immediately prior to use (tank mix). For example, the plant(s) may be sprayed with a composition of this invention either before or after being treated with other active ingredients. Any of the aforementioned additional ingredients can be admixed with the agents according to the invention in a weight ratio of 1:100 to 100:1.

The pests as defined hereinabove may be controlled by contacting the pest, its food supply, habitat, breeding ground or its locus with pesticidally effective amounts of piperonyl butoxide and the pyrethroid.

“Locus” means a habitat, breeding ground, plant, seed, soil, area, material or environment in which the pest is growing or may grow.

The pests may also be controlled by contacting the plant—typically to the foliage, stem or roots of the—with pesticidally effective amounts of piperonyl butoxide and the pyrethroid.

In general, “pesticidally effective amount” means the amount of active ingredient needed to achieve an observable effect on growth, including the effects of necrosis, death, retardation, prevention, and removal, destruction, or otherwise diminishing the occurrence and activity of the pests as defined hereinabove. The pesticidally effective amount can vary for the various compounds/compositions used in the invention. A pesticidally effective amount of the compositions will also vary according to the prevailing conditions such as desired pesticidal effect and duration, weather, target species, locus, mode of application, and the like.

Piperonyl butoxide and the pyrethroid can be applied simultaneously (together or separately) or subsequently, the sequence, in the case of separate application, generally not having any effect on the result of the control measures. It is preferred, however, that piperonyl butoxide is applied prior to the application of the pyrethroid.

The term “applied simultaneously” should also be understood to mean that piperonyl butoxide and the pyrethroid are applied twice or more than twice (each time together or separately) to e.g. the plant and/or the pest. For example, two applications of piperonyl butoxide and the pyrethroid can be carried out shortly after each other (e.g. within 3 to 14 days), with piperonyl butoxide and the pyrethroid being preferably applied together in each application.

In another embodiment, piperonyl butoxide is applied in a non-fast released form. For this purpose, any non-immediate release formulation known in the art, such as sustained, controlled or slow release formulations may be suitable. Preferably, the non-fast release formulation is one that ensures that an effective amount of piperonyl butoxide is released or comes into contact with the plant and/or the pest over a prolonged period of time while the pyrethroid is applied simultaneously to the plant and/or the pest. Such formulations include, for example, piperonyl butoxide encapsulated in a degradable capsule and preferably comprise micro-encapsulation formulations comprising piperonyl butoxide.

In another embodiment, piperonyl butoxide and/or the pyrethroid is used in combination with at least one adjuvant that improves its adherence to the plant or the pest.

Examples of adjuvants suitable for this purpose include solvents, wetting agents, sticking agents, spreaders, and penetrating agents.

Piperonyl butoxide and the pyrethroid are generally applied in a weight ratio of from 0.0001 to 10000, preferably from 0.02 to 4000, more preferably from 0.1 to 100 and in particular from 1 to 50.

Piperonyl butoxide and the pyrethroid are effective against the pests as defined hereinabove through both contact (via soil or plant parts) and ingestion (plant part) or by direct contact with the insect.

For use in treating crop plants, the rate of application per treatment of piperonyl butoxide may be in the range of 1 to 2000 g per hectare (g/ha), preferably from 25 to 2000 g/ha, more preferably from 50 to 500 g/ha and in particular from 100 to 400 g/ha. The rate of application per treatment of the pyrethroid may be in the range of 0.1 to 300 g/ha, preferably from 0.5 to 100 g/ha, more preferably from 1 to 60 g/ha and in particular from 1 to 40 g/ha. Such treatments could be up to 5 and preferably up to 3 times per season in the related crop.

The present invention will be illustrated by the following Examples.

### EXAMPLE

Experiments were carried out on a commercial oilseed rape field location previously confirmed to have adult pollen beetles with resistance against pyrethroids. The experiments were carried out according the GEP settings for field trial set up and corresponding assessment of the treatments. The lay-out was a standard randomized block de-sign with 4 replicates. The different treatments (see Table 1 below) were prepared by diluting the respective products in water by well homogenized standard stirring in order to spray the four replicates at a spray volume of 300 to 400 liter per ha. The products used were the commercial formulation Fastac® OESC (containing 100 g per liter alpha-cypermethrin) and an experimental liquid formulation (containing 303.5 g PBO on a weight per weight basis). The three combinations of Fastac® OESC and the PBO containing liquid formulation in the Table 1 below were made as a tank mix of a standard rate of Fastac® OESC and a varying rate for the PBO containing formulation. The treatments were sprayed on the plants and the adult pollen beetles present on the plant by means of a knapsack sprayer at standard air pressure. The treatments were applied shortly after each other by appropriate rinsing in between according the GEP standard procedure. The development growth stage of the oilseed rape according to the BBCH code at the time of the treatment was 50 to 59 (the abbreviation “BBCH” stands for the Biologische Bundesanstalt, Bundessortenamt and Chemische Industrie). Shortly before the treatment the present adult pollen beetles were assessed in counting the number of adult pollen beetles present on 50 inflorescences—randomly taken—in each of the replicates. The total number of adult pollen beetles on the 4 replicates was then divided by 4 to give the average number of living adult pollen beetles per 50 inflorescenses, mentioned in the Table 1 below. The same procedure was followed respectively 3 and 6 days after the treatment (DAT). The results are given in the Table 1 below.

TABLE 1

| | Application | Average number of living adult | | |
|---|---|---|---|---|
| | rate(s) | pollen beetles per 50 inflorescenses | | |
| Treatment | g a.i./ha | 0 DAT | 3 DAT | 6 DAT |
| untreated | — | 353 | 192 | 198 |
| alpha-cypermethrin | 7.5 | 343 | 119 | 75 |
| alpha-cypermethrin | 12.5 | 352 | 116 | 79 |
| PBO + alpha- | 400 + 7.5 | 357 | 20 | 28 |
| cypermethrin | | | | |
| PBO + alpha- | 200 + 7.5 | 361 | 41 | 42 |
| cypermethrin | | | | |
| PBO + alpha- | 100 + 7.5 | 355 | 61 | 45 |
| cypermethrin | | | | |

The test results show that the combined application of piperonyl butoxide and alpha-cypermethrin as the pyrethroid provided commercially acceptable control of pyrethroid-resistant adult pollen beetles in oilseed rape crops at the chosen application rates.

1-13. (canceled)

14. A method of preventing or reducing pyrethroid resistance of adult insect pests selected from the family Nitidulidae which method comprises contacting the plant or the soil or water in which the plant is growing, or the pest or its food supply, habitat, breeding grounds or locus, with pesticidally effective amounts of piperonyl butoxide and at least one pyrethroid, wherein piperonyl butoxide and the pyrethroid are applied in a weight ratio of from 0.0001 to 10000 and the pyrethroid is selected from the group consisting of bifenthrin, alpha-cypermethrin, etofenprox, lambda-cyhalothrin, pyrethrin I and II, and taufluvalinate.

15. The method of claim 14 wherein the pyrethroid is alpha-cypermethrin.

16. The method of claim 14 wherein the pyrethroid is lambda-cyhalothrin.

17. The method of claim 14 wherein the pest is selected from Meligethes ssp.

18. The method of claim 17 wherein the pest is Meligethes aeneus.

19. The method of claim 14 wherein the plant is selected from Brassica spp.

20. The method of claim 19 wherein the plant is oilseed rape.

21. The method of claim 14 wherein piperonyl butoxide and the pyrethroid are applied simultaneously (together or separately) or subsequently.

22. The method of claim 14 wherein piperonyl butoxide is applied prior to the application of the pyrethroid.

23. The method of claim 14 wherein piperonyl butoxide and/or the pyrethroid is applied in combination with at least one adjuvant that improves its adherence to the plant or the pest.

24. The method of claim 14 wherein piperonyl butoxide and the pyrethroid are applied in a weight ratio of from 1 to 100.

25. The method of claim 14 wherein piperonyl butoxide is applied in an amount of from 50 to 500 g/ha.

26. The method of claim 14 wherein the pyrethroid is applied in an amount of from 0.1 to 300 g/ha.
